(19) United States
(12) Patent Application Publication
(10) Pub. No.: US 2021/0229655 A1
(43) Pub. Date: Jul. 29, 2021

(54) SYSTEMS AND METHODS FOR EXECUTING AUTOMATED VEHICLE MANEUVERING OPERATIONS

(71) Applicant: Ford Global Technologies, LLC, Dearborn, MI (US)

(72) Inventors: Lawrence Chikeziri Amadi, Chicago, IL (US); Erick Michael Lavoie, Van Buren Charter Township, MI (US); John Robert Van Wiemeersch, Novi, MI (US)

(73) Assignee: Ford Global Technologies, LLC, Dearborn, MI (US)

(21) Appl. No.: 16/775,251

(22) Filed: Jan. 28, 2020

(51) Int. Cl. B60W 30/06; G05D 1/00; G06F 3/0488; G06F 3/0486; G06F 3/0481; B60W 50/14; G06F 3/01; G06F 3/16

(52) U.S. Cl. CPC B60W 30/06; G05D 1/0016; G06F 3/0488; G06F 3/0486; B60W 2050/0002; G06F 3/04817; B60W 50/14; G06F 3/016; G06F 3/167; G06F 3/04815

(57) ABSTRACT

The disclosure is generally directed to systems and methods for executing an automated vehicle maneuvering operation. In one exemplary scenario, a driver stands on a curb and uses an application in a handheld device to execute a remote parking assist operation of his/her vehicle. The application may use a camera of the handheld device to provide to the driver, an image of a group of vehicles that includes his/her vehicle. The driver identifies his/her vehicle by dragging and dropping an icon upon the vehicle. The application then pairs the handheld device to the vehicle by instructing the vehicle to provide an audible and/or visual signal (beeps, flashing lights, etc.) to confirm the pairing. Upon pairing, a visual lock that is established by the application between the handheld device and the vehicle is used by the driver to automatically track and monitor the automated parking operation carried out by the vehicle.

### FIELD OF THE DISCLOSURE

This disclosure generally relates to vehicles, and more particularly relates to systems and methods for executing automated vehicle maneuvering operations.

### BACKGROUND

One significant area of focus in automobile developmental efforts over the years is automation. Automation is typically directed at relieving human drivers of various driving activities. For example, some types of automation such as cruise-control systems and anti-skid braking systems, may assist a driver when a vehicle is driving on a long stretch of an empty highway or on a wet road. Some other types of automation such as lane assist technology, blind spot warning, and drowsiness detection systems may prevent accidents.

The ultimate goal of automation is a fully autonomous vehicle that can operate with no human intervention. However, operating a fully autonomous vehicle on public roads involves providing a large amount of equipment in the autonomous vehicle (electrical equipment, imaging equipment, processing equipment etc.) thereby raising the cost of the autonomous vehicle. A balance may be struck between high cost and extensive driver interaction by requiring a certain level of human participation for carrying out some types of operations in a vehicle that is not fully autonomous. For example, as executed presently, a parking operation performed by a vehicle that is partially autonomous may necessitate certain actions to be carried out by an individual who is standing on a curb and monitoring the movements of the vehicle via a handheld device. Some of the actions to be performed by the individual upon the handheld device, during this procedure can be tedious and complex, while others may tend to be unreliable. In an exemplary situation, the individual may make a mistake while operating the handheld device. As a result, the vehicle may stop abruptly at an awkward angle and pose inconvenience to the individual. In another exemplary operation, as executed currently, the individual may be required to place his/her finger on a touchscreen of the handheld device and perform an orbital motion on the touchscreen in order to provide an indication that he/she is alert and aware of the parking operation being executed by the vehicle. Such an operation can turn out to be tedious and/or error prone.

It is therefore desirable to provide solutions that address at least some of such shortcomings associated with using a handheld device for monitoring certain automated maneuvers carried out by a vehicle.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an exemplary vehicle maneuvering system for performing remote vehicle maneuvering and monitoring operations upon an automated vehicle in accordance with the disclosure.

FIG. 2 illustrates an exemplary scenario where the vehicle maneuvering system may be used to execute a vehicle maneuvering operation in accordance with the disclosure.

FIG. 3 illustrates a first exemplary screenshot of a display screen of a handheld device that is used to execute an automated vehicle maneuvering operation upon a vehicle in accordance with the disclosure.

FIG. 4 illustrates a second exemplary screenshot of a display screen of a handheld device that is used to execute an automated vehicle maneuvering operation upon a vehicle in accordance with the disclosure.

FIG. 5 illustrates another exemplary scenario where the vehicle maneuvering system may be used to execute a vehicle maneuvering operation in accordance with the disclosure.

FIG. 6 illustrates a third exemplary screenshot of a display screen of a handheld device that is used to execute an automated vehicle maneuvering operation upon a vehicle in accordance with the disclosure.

FIG. 7 illustrates a fourth exemplary screenshot of a display screen of a handheld device that is used to execute an automated vehicle maneuvering operation upon a vehicle in accordance with the disclosure.

FIG. 8 shows some exemplary components that can be included in a handheld device used for executing an automated vehicle maneuvering operation upon a vehicle in accordance with the disclosure.

FIG. 9 shows some exemplary components that can be included in a computer that is provided in a vehicle for executing automated vehicle maneuvering operations in accordance with the disclosure.

### DETAILED DESCRIPTION

### Overview

In terms of a general overview, this disclosure is generally directed to systems and methods for executing an automated vehicle maneuvering operation upon a vehicle. In one exemplary scenario, a driver of a vehicle may stand on a curb and perform certain operations upon a handheld device in order to execute a remote parking assist operation of his/her vehicle. As a part of this procedure, the driver may launch an application in the handheld device and use the application to examine an image of a group of vehicles that includes his/her vehicle. The driver then identifies his/her vehicle by performing an action such as dragging and dropping an icon upon the vehicle. The application then carries out a pairing operation to pair the handheld device to the vehicle. The pairing operation may include actions such as instructing the vehicle to provide an audible signal (beep) and/or visual signal (flashing lights) that is recognizable by the handheld device. The application establishes a visual lock between the handheld device and the vehicle upon establishing the pairing. The visual lock can be used to automatically track the automated parking operation carried out by the vehicle.

### Illustrative Embodiments

The disclosure will be described more fully hereinafter with reference to the accompanying drawings, in which exemplary embodiments of the disclosure are shown. This disclosure may, however, be embodied in many different forms and should not be construed as limited to the exemplary embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described exemplary embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. It should also be understood that the word “example” as used herein is intended to be non-exclusionary and non-limiting in nature. More particularly, the word “exemplary” as used herein indicates one among several examples, and it should be understood that no undue emphasis or preference is being directed to the particular example being described.

Furthermore, certain words and phrases that are used herein should be interpreted as referring to various objects and actions that are generally understood in various forms and equivalencies by persons of ordinary skill in the art. For example, the word “application” as used herein with respect to a handheld device such as a smartphone, refers to code (software code, typically) that is installed in the handheld device and may be provided in the form of a human machine interface (HMI). The word “automated” may be used interchangeably with the word “autonomous” in the disclosure. It must be understood that either word generally pertains to a vehicle that can execute certain operations without involvement of a human driver. The word “vehicle” as used in this disclosure can pertain to any one of various types of vehicles such as cars, vans, sports utility vehicles, trucks, electric vehicles, gasoline vehicles, hybrid vehicles, and autonomous vehicles. The phrase “automated vehicle” or “autonomous vehicle” as used in this disclosure generally refers to a vehicle that can perform at least a few operations without human intervention. At least some of the described embodiments are applicable to Level 2 vehicles, and may be applicable to higher level vehicles as well. The Society of Automotive Engineers (SAE) defines six levels of driving automation ranging from Level 0 (fully manual) to Level 5 (fully autonomous). These levels have been adopted by the U.S. Department of Transportation. Level 0 (L0) vehicles are manually controlled vehicles having no driving related automation. Level 1 (L1) vehicles incorporate some features, such as cruise control, but a human driver retains control of most driving and maneuvering operations. Level 2 (L2) vehicles are partially automated with certain driving operations such as steering, braking, and lane control being controlled by a vehicle computer. The driver retains some level of control of the vehicle and may override certain operations executed by the vehicle computer. Level 3 (L3) vehicles provide conditional driving automation but are smarter in terms of having an ability to sense a driving environment and certain driving situations. Level 4 (L4) vehicles can operate in a self-driving mode and include features where the vehicle computer takes control during certain types of equipment failures. The level of human intervention is very low. Level 5 (L5) vehicles are fully autonomous vehicles that do not involve human participation.

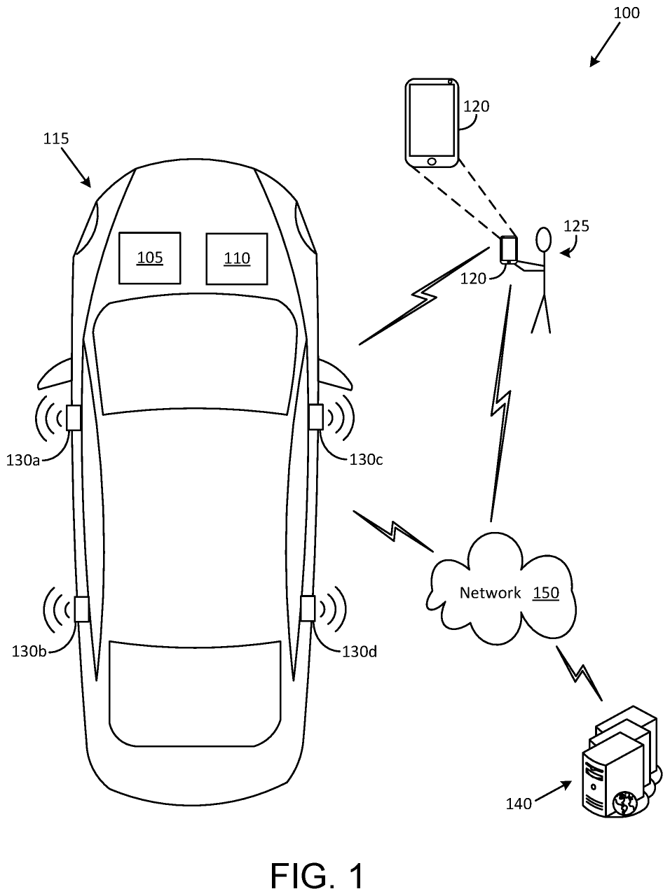

FIG. 1 illustrates an exemplary vehicle maneuvering system 100 for performing remote vehicle maneuvering and monitoring operations upon a vehicle 115. The vehicle 115 may be one of various types of vehicles such as a gasoline powered vehicle, an electric vehicle, a hybrid electric vehicle, or an autonomous vehicle, that is configured as a Level 2 (or higher) automated vehicle. The vehicle maneuvering system 100 may be implemented in a variety of ways and can include various types of devices. For example, the vehicle maneuvering system 100 can include some components that are a part of the vehicle 115, some that may be carried by an individual 125, and others that may be accessible via a communications network 150. The components that can be a part of the vehicle 115 can include a vehicle computer 105, an auxiliary operations computer 110, and a wireless communication system. Components that may be carried by the individual 125 can include a handheld device 120 such as a smartphone, a tablet computer, a phablet (phone plus tablet or an iPod Touch®). Components that may be accessible by the vehicle computer 105, the auxiliary operations computer 110, and/or the handheld device 120, via the communications network 150, can include a server computer 140.

The vehicle computer 105 may perform various functions such as controlling engine operations (fuel injection, speed control, emissions control, braking, etc.), managing climate controls (air conditioning, heating etc.), activating airbags, and issuing warnings (check engine light, bulb failure, low tire pressure, vehicle in blind spot, etc.).

The auxiliary operations computer 110 may be used to support features such as passive keyless operations, remote vehicle maneuvering operations, and remote vehicle monitoring operations. In some cases, some or all of the components of the auxiliary operations computer 110 may be integrated into the vehicle computer 105, which can then execute certain operations associated with remote vehicle maneuvering and/or remote vehicle monitoring in accordance with the disclosure. The operations associated with remote vehicle maneuvering and/or remote vehicle monitoring in accordance may be executed by the vehicle computer 105 independently or in cooperation with the auxiliary operations computer 110.

The wireless communication system can include a set of wireless communication nodes 130a, 130b, 130c, and 130d mounted upon the vehicle 115 in a manner that allows the auxiliary operations computer 110 and/or the vehicle computer 105 to communicate with devices such as the handheld device 120 carried by the individual 125. In an alternative implementation, a single wireless communication node may be mounted upon the roof of the vehicle 115. The wireless communication system may use one or more of various wireless technologies such as Bluetooth®, Ultra-Wideband (UWB), Wi-Fi, Zigbee®, Li-Fi (light based communication), audible communication, ultrasonic communication, or near-field-communications (NFC), for carrying out wireless communications with devices such as the handheld device 120.

The auxiliary operations computer 110 and/or the vehicle computer 105 can utilize the wireless communication system to communicate with the server computer 140 via the communications network 150. The communications network 150 may include any one network, or a combination of networks, such as a local area network (LAN), a wide area network (WAN), a telephone network, a cellular network, a cable network, a wireless network, and/or private/public networks such as the Internet. For example, the communications network 150 may support communication technologies such as Bluetooth®, cellular, near-field communication (NFC), Wi-Fi, Wi-Fi direct, Li-Fi, machine-to-machine communication, and/or man-to-machine communication. At least one portion of the communications network 150 includes a wireless communication link that allows the server computer 140 to communicate with one or more of the wireless communication nodes 130a, 130b, 130c, and 130d on the vehicle 115. The server computer 140 may communicate with the auxiliary operations computer 110 and/or the vehicle computer 105 for various purposes such as for password registration and/or password verification when the handheld device 120 is used as a phone-as-a-key (PaaK) device.

The PaaK feature that may be provided in the handheld device 120 in the form of an application, allows the individual 125 to use the handheld device 120 for performing actions such as locking and unlocking of the doors of the vehicle 115 and to enable the use of an engine-start push-button in the vehicle 115 (eliminating the need to insert a key into an ignition lock). The handheld device 120 may communicate with the vehicle computer 105 via one or more of the first set of wireless communication nodes 130a, 130b, 130c, and 130d so as to allow the individual 125 (a driver, for example) to start the engine before entering the vehicle 115.

The handheld device 120 may also be used by the individual 125 to remotely perform certain maneuvering-related operations upon the vehicle. For example, in accordance with the disclosure, the individual 125, who may be driving the vehicle 115, gets out of the vehicle 115 and uses the handheld device 120 to remotely initiate an autonomous parking procedure of the vehicle 115. During the autonomous parking procedure, the vehicle 115 moves autonomously to park itself at a parking spot located near the individual 125. In one case, the vehicle 115 can be a L2 level vehicle that performs a parking maneuver without human assistance. The individual 125 monitors the movement of the vehicle 115 during the parking maneuver so as to minimize the chances of an accident taking place.

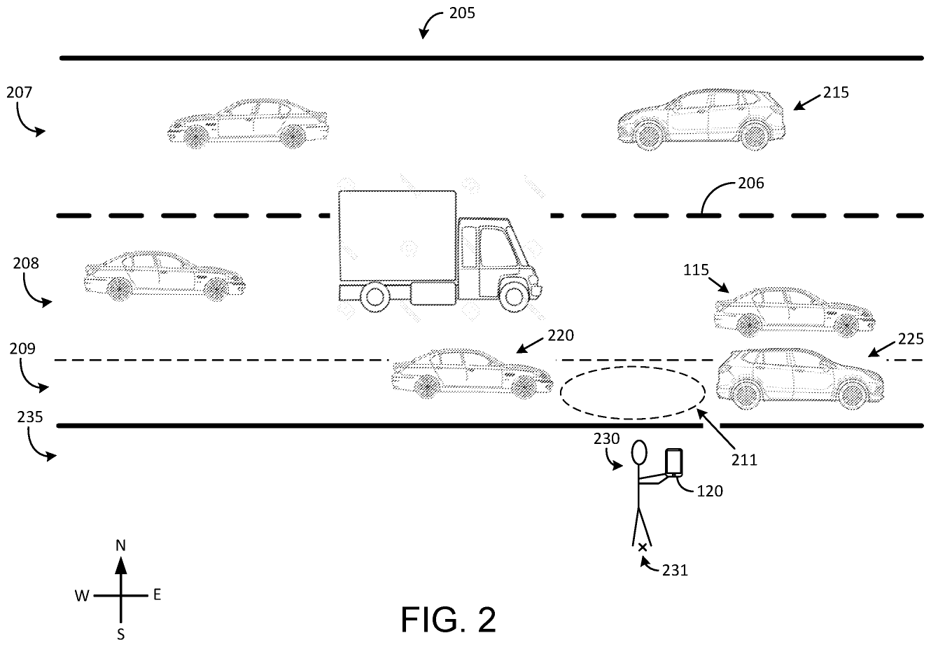

FIG. 2 illustrates an exemplary scenario where the vehicle maneuvering system 100 may be used to execute a vehicle maneuvering operation upon the vehicle 115 in accordance with the disclosure. The vehicle 115 may be a L2 vehicle or any other type of vehicle that can execute an autonomous driving maneuver such as, for example, an autonomous parking maneuver. In this exemplary scenario, the driver 230 has exited the vehicle 115 and is standing on a curb 235 beside a highway 205. The highway 205 is a divided highway with a median 206 demarcating a lane 207 in which vehicles travel westwards and a lane 208 in which vehicles travel eastwards. A parking lane 209 is provided beside the lane 208 for parking vehicles facing eastwards. The driver 230 has exited the vehicle 115 after noticing an unoccupied parking spot 211 between a vehicle 225 and a vehicle 220 that are parked in the parking lane 209. The driver 230 may then stand at a spot 231 on the curb 235 and launch a vehicle maneuvering application installed in the handheld device 120. In one case, the handheld device 120 is a smartphone with a built-in camera. The vehicle maneuvering application may provide to the driver 230, an instruction such as: “Point the camera towards the vehicle you wish to park.”

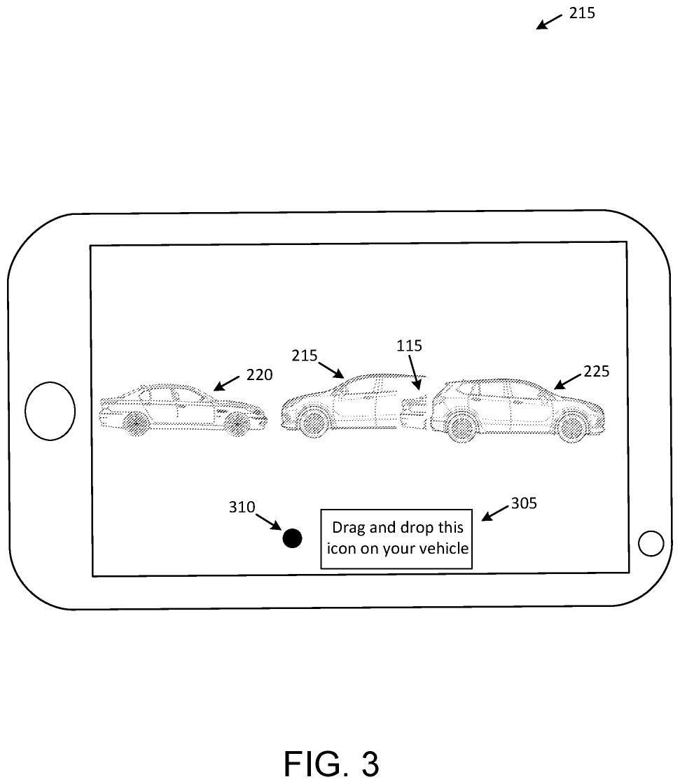

FIG. 3 illustrates an exemplary image displayed upon a display screen of the smartphone when the driver 230 points the camera of the smartphone towards the vehicle 115. The image can be a real-time image that is displayed as a part of a videoclip. The videoclip can be used by the driver 230 to monitor the vehicle 115 when the vehicle 115 is executing the autonomous parking maneuver. The vehicle maneuvering application provided in the smartphone may then initiate an object recognition procedure for identifying the various vehicles present in the displayed image. In one case, the object recognition procedure may utilize a pre-trained object recognition deep learning model for identifying the various vehicles present in the displayed image.

The results of the object recognition procedure may be indicated upon the display screen of the smartphone in various ways. In one exemplary case, each identified vehicle may be highlighted with a distinct color. This action may be carried out by overlaying a transparent colored mask upon the identified vehicle. A set of icons (buttons or circles, for example) each having a color that matches an identified vehicle, may also be displayed upon the display screen. An instruction may be provided for the driver 230 to drag and drop a matching icon upon the transparent colored mask of the vehicle 115. For example, a green icon may be dragged and dropped upon a vehicle that is highlighted in green (using a transparent green mask, for example).

The image displayed upon the display screen of the smartphone in this exemplary case includes the vehicle 115 and three neighboring vehicles (the vehicle 220, the vehicle 215, and the vehicle 225). However, at a different time, traffic on the highway 205 may be heavy and many more vehicles may be present in the displayed image. When many vehicles are present on the highway 205, the object recognition procedure of the vehicle maneuvering application may process an image and highlight only a subset of the displayed vehicles for purposes of identification by the driver 230.

In one case, the subset of displayed vehicles that are highlighted may be based on information stored in a memory device of the smartphone. The stored information may, for example, pertain to instances where the smartphone was used to pair to the vehicle 115. In an exemplary scenario, the vehicle 115 may be a Ford Explorer® and the smartphone may have been used to pair to the Ford Explorer®. The vehicle maneuvering application may use this information to highlight vehicles that are either a Ford Explorer® or resemble a Ford Explorer®. If an inadequate number of such vehicles are present, the vehicle maneuvering application may highlight various other vehicles by using other criteria. This action may be performed so as to provide the driver 230 an option to make a selection from an adequate number of vehicles.

In the exemplary scenario that is illustrated in FIG. 3, the vehicle maneuvering application may also display an icon 310 accompanied by an instruction 305 such as, for example: “Drag and drop this icon upon your vehicle.” The driver 230 may respond to the instruction 305 by dragging and dropping the icon 310 upon the vehicle 115. The vehicle maneuvering application may confirm a success of the operation in one of various ways such as by providing a message or by modifying an appearance of the vehicle 115 (changing a color of the vehicle 115 to green, for example). In some cases, the other vehicles in the image can be de-emphasized in various ways such as by lightening a color of each vehicle, or by reducing a display intensity of these other vehicles.

In the example scenario illustrated in FIG. 3, only a rear-end portion of the vehicle 115 is visible to the camera from the spot 231 on the curb 235. For safety purposes, such as in order to avoid coming in contact with the parked vehicle 225, it is desirable that more of the vehicle 115 be visible to the driver in the real-time image. Consequently, the vehicle maneuvering application may provide further instructions to the driver 230 in accordance with a minimum visibility requirement that may be included in the vehicle maneuvering system 100. For example, a minimum visibility requirement of at least 30% of the vehicle 115 may be required for using the vehicle maneuvering application to execute the autonomous parking maneuver. A message may be displayed upon the display screen of the smartphone in this example case requesting the driver 230 to confirm his/her identification of the partially obscured vehicle 115. Displaying of such a message may be withheld when the vehicle 115 is visible to the driver 230 in its entirety.

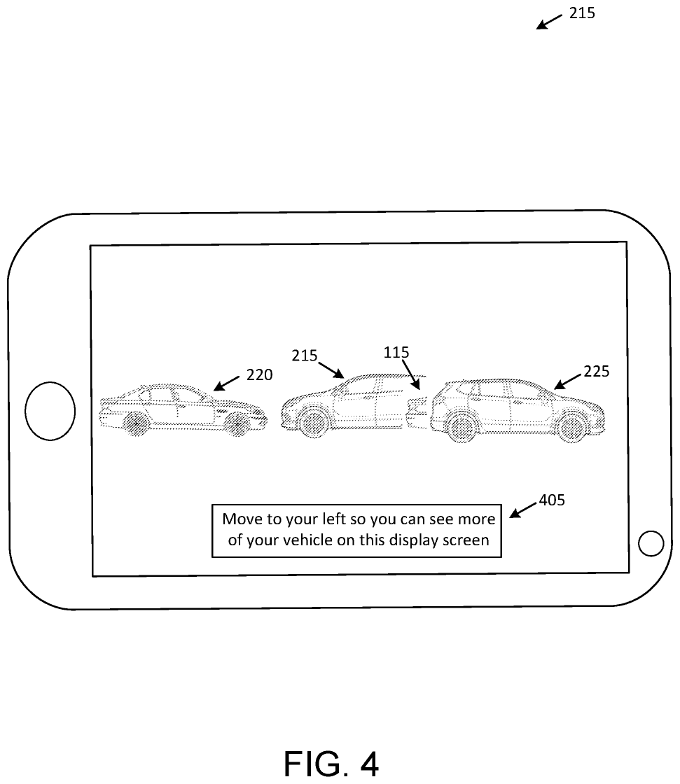

FIG. 4 shows an exemplary instruction 405 displayed upon the display screen of the smartphone advising the driver 230 to move to a new spot on the curb 235 so as to obtain a better view of the vehicle 115.

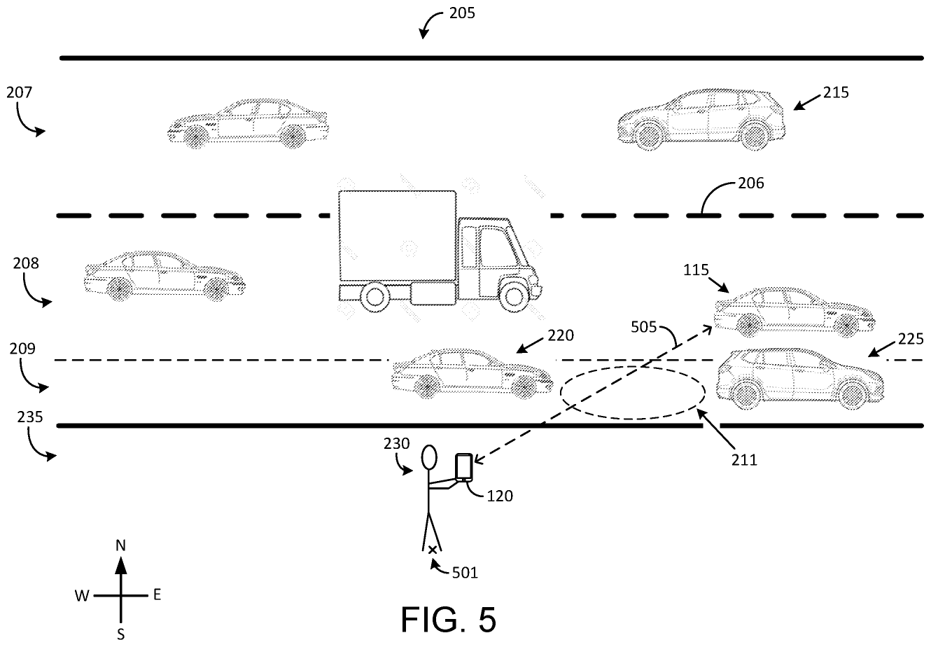

FIG. 5 shows the driver 230 having moved from the spot 231 to a spot 501 on the curb 235 in response to the instruction 405 provided by the vehicle maneuvering application. The vehicle maneuvering application may verify whether the image obtained by the camera satisfies the minimum visibility requirement. If found unsatisfactory, the vehicle maneuvering application may provide additional instructions to reposition the driver 230 at another spot.

In some cases, the vehicle maneuvering application may provide instructions to the driver 230 in order to satisfy a maximum separation distance requirement between the driver 230 and the vehicle 115. The maximum separation distance requirement may be specified by one or more of various entities such as, for example, a manufacturer of the vehicle 115 or a government agency, as a safety precaution when the vehicle 115 executes the autonomous parking maneuver. For example, a safety regulation of the United Nations Economic Commission for Europe Regulation (ECE-79R) specifies that a separation distance between a driver and a vehicle should not exceed 6 meters when the vehicle is executing a remote autonomous parking maneuver. The separation distance between the driver 230 and the vehicle 115 is indicated by a line-of-sight 505 between the camera of the smartphone and the vehicle 115.

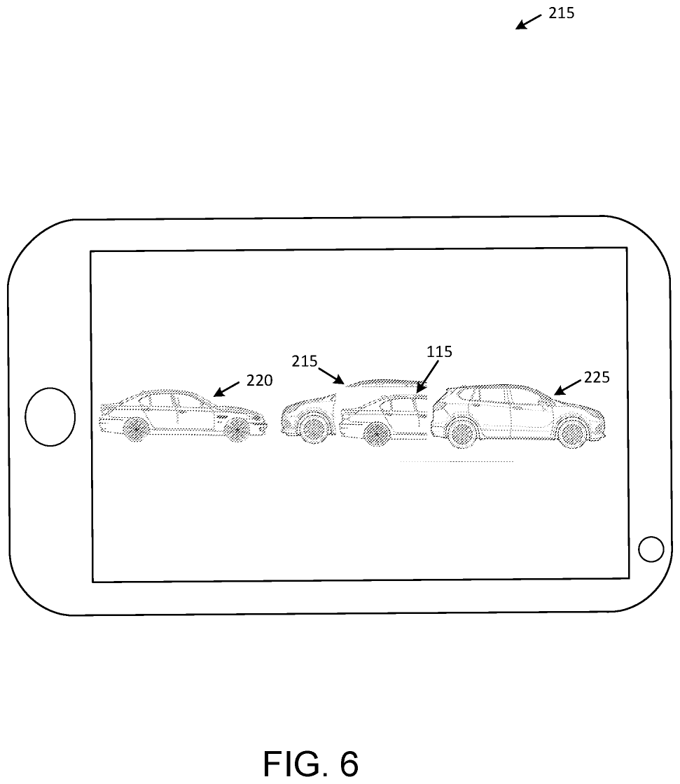

FIG. 6 illustrates an exemplary image displayed upon the display screen of the smartphone when the driver 230 has moved from the spot 231 to the spot 501 on the curb 235. The vehicle maneuvering application may process the new image displayed on the display screen to determine whether the new image satisfies the minimum visibility requirement. In this example, more than 30% (or any such designated value) of the vehicle 115 is visible on the smartphone, thereby satisfying the minimum visibility requirement.

In addition to verifying the minimum visibility requirement, the vehicle maneuvering application may use components provided in the smartphone to carry out a distance measurement operation for determining whether the spot 501 satisfies the maximum separation distance requirement between the driver 230 and the vehicle 115.

Upon satisfying the minimum visibility requirement and/or the maximum separation distance requirement, the vehicle maneuvering application may execute a linking procedure to link the smartphone to the auxiliary operations computer 110 and/or the vehicle computer 105 of the vehicle 115. The linking procedure can include communications between the smartphone and the auxiliary operations computer 110 and/or vehicle computer 105 that cause the vehicle 115 to flash one or more of its lamps (tail lamps, hazard lamps, turns signal lamps, etc.) in a unique sequence that is recognizable by the smartphone. The vehicle maneuvering application establishes a visual pairing between the smartphone and the vehicle 115 subject to validating the flashing light sequence. The visual pairing may be confirmed by a visual lock that may be indicated on the smartphone in various ways. If the vehicle maneuvering application fails to recognize the flashing light sequence, or the flashing light sequence is originating from a vehicle other than that indicated by the driver 230, the object recognition procedure described is re-executed for carrying out an identification of the vehicle 115.

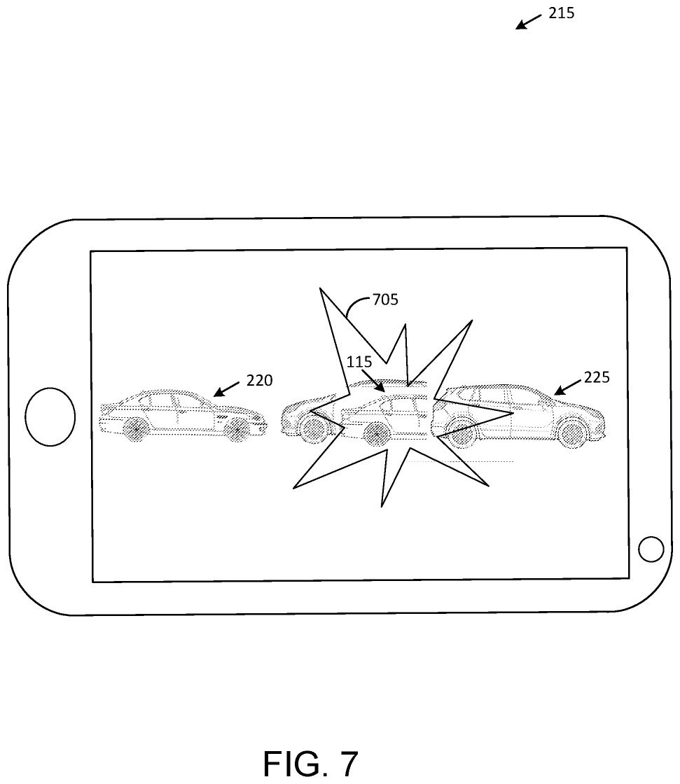

FIG. 7 illustrates an exemplary visual lock indication that is provided in the form of a flashing icon 705 around the vehicle 115. The flashing icon 705 may be provided in different colors to indicate a strength of the visual lock. For example, a strong visual lock may be indicated by a green-colored flashing icon 705, a weak visual lock by a yellow-colored flashing icon 705, and a loss-of-lock by a red-colored flashing icon 705.

The vehicle maneuvering application ensures that the driver 230 remains actively involved in the autonomous parking maneuver in various ways. In one example procedure, the driver 230 is instructed to press and hold down a button on the smartphone (for example, a volume control button) while the vehicle 115 is executing the autonomous parking maneuver. In another example procedure, the driver 230 is instructed to make and retain finger contact upon an icon that is displayed on the display screen of the smartphone when the display screen is a touchscreen. No additional action, such as moving the finger in a circular motion upon the touchscreen, is required.

The vehicle maneuvering application may abort the autonomous parking maneuver, or modify the autonomous parking maneuver, if the driver 230 fails to hold down the depressed button or fails to retain finger contact with the icon. Aborting or modifying the autonomous parking maneuver may be executed in a precautionary manner so as to avoid undesirable events such as a traffic collision or obstruction of traffic. For example, the vehicle maneuvering application may instruct the computer in the vehicle to switch on its hazard lights and/or sound a vehicle horn to warn the driver 230 and others that the vehicle 115 is aborting the autonomous parking maneuver.

The visual lock indication that is provided in the form of the flashing icon 705 around the vehicle 115, is one of several ways by which the vehicle maneuvering application indicates a tracking status when the vehicle 115 is executing the autonomous parking maneuver. The tracking status may be also indicated by using audio signals or haptic signals produced by the smartphone. Some exemplary scenarios pertaining to tracking status are provided below.

In a first exemplary scenario, a focused image of the vehicle 115 is displayed on the display screen of the smartphone to indicate that the vehicle 115 is being tracked confidently by the vehicle maneuvering application. In this scenario, the driver 230 has not moved beyond the maximum separation distance between the driver 230 and the vehicle 115, and is actively participating in the autonomous parking maneuver (for example, by holding down the depressed button or retaining finger contact with the icon on the touch screen). The flashing icon 705 around the vehicle 115 stays green. When an audio signal is used, for example, in the form of a tapping sound, a ticking sound, a pure tone or a modulated tone, the tracking status in this first scenario may be indicated by the audio signal having a first characteristic. The first characteristic may be a first repetition frequency of the tapping or ticking sound, a first frequency of the pure tone, or a first modulation characteristic of the modulated tone.

In a second exemplary scenario, a defocused image of the vehicle 115 is displayed upon the display screen and the tracking confidence associated with the vehicle maneuvering application has reduced. The defocused image may be caused by various factors such as the driver 230 and/or the vehicle 115 moving in a direction that tends towards a violation of the maximum separation distance between the driver 230 and the vehicle 115 and/or a violation of the minimum visibility requirement. The defocused image may also be caused by the driver 230 handling the smartphone in an improper manner, such as by involuntarily moving the field of view of the camera and placing the vehicle 115 away from a center of the display screen. Yet another factor that may lead to the defocused image may be an adverse lighting condition such as a headlight from another vehicle that may be inadvertently directed at the camera of the smartphone.

Based on such factors, the flashing icon 705 around the vehicle 115 may turn yellow and may flash at a different rate. When an audio signal is used, the first characteristic of the audio signal may change to a second characteristic. For example, the first repetition frequency of the tapping sound or ticking sound may change to a second repetition frequency, the first frequency of the pure tone may change to a second frequency and the first modulation characteristic of the modulated tone may change to a second modulation characteristic. The changes in the flashing icon 705 or audio signals may also be selected to reflect a confidence level of the vehicle maneuvering application in tracking the vehicle 115. In some cases, an advisory message may be displayed to advise the driver 230 on how to improve the visual lock. The driver 230 may respond to the changes and attempt to perform remedial actions to regain satisfactory tracking status.

In a third exemplary scenario, tracking of the vehicle 115 by the smartphone has failed. The failure can occur due to various reasons, such as, for example, the driver 230 and/or the vehicle 115 moving to a new location that violates the minimum visibility requirement and/or the maximum separation distance. The vehicle maneuvering application may abort the autonomous parking maneuver or modify the autonomous parking maneuver when tracking has failed. Failure of the tracking can be indicated to the driver 230 in various ways. For example, the flashing icon 705 around the vehicle 115 may turn bright red and flash rapidly to attract the attention of the driver 230. As another example, a background color of at least a portion of the display screen of the smartphone may change color (to red, for example) to indicate the tracking failure. As yet another example, a characteristic of an audio signal and/or a haptic signal may be modified to attract the attention of the driver 230. In some cases, an advisory message may be displayed to advise the driver 230 on how to re-establish the visual lock. In yet some other cases, a message may be displayed on the smartphone providing an explanation for the tracking failure. The explanation may, for example, clarify that a movement of the driver 230 has caused the tracking failure, a movement of the vehicle 115 has caused the tracking failure, and/or a relative movement between the driver 230 and the vehicle 115 has caused the tracking failure.

A duration of the failure indication (flashing icon 705, screen color change, sound modification, etc.) may be determined in some implementations by the use of a timer in the smartphone. For example, upon expiry of a preset period of the timer, the flashing icon 705 may have a reduced flash rate or may stop flashing entirely. The duration of the failure indication (flashing icon 705, screen color change, sound modification, etc.) may be determined in some other applications by a status of the vehicle 115. For example, the flashing icon 705 may stop flashing when the vehicle 115 has come to a halt in response to the tracking failure. The condition of the flashing icon 705 and/or the display screen may be reset to a default condition or active condition when tracking is re-established.

In a fourth exemplary scenario, the driver 230 moves away from the spot 501 (shown in FIG. 5) in a direction that tends to violate the maximum separation distance requirement. For example, the movement of the driver 230 may lead to a separation distance that is close to a specified 6-meter maximum separation distance (a separation distance of 5.5 meters, for example). Under this condition, the vehicle maneuvering application may warn the driver 230 in various ways. For example, the intensity of the flashing icon 705 may be reduced, a color of the flashing icon 705 may be changed (from green to yellow, for example), a characteristic of an audio signal and/or a haptic signal may be modified, and/or a warning message displayed. The warning message may instruct the driver 230 to move closer towards the vehicle 115.

In a fifth exemplary scenario, the driver 230 moves away from the spot 501 (shown in FIG. 5) in a direction and violates the maximum separation distance requirement. For example, the movement of the driver 230 may lead to a separation distance that approaches or exceeds the specified 6-meter maximum separation distance. Under this condition, the vehicle maneuvering application may warn the driver 230 in various ways. For example, the intensity of the flashing icon 705 may be increased as the separation distance approaches a first threshold, a color of the flashing icon 705 may be changed (from yellow to red, for example) when the separation distance exceeds a second threshold, a characteristic of an audio signal and/or a haptic signal may be modified (reduced intensity or stopped, for example), and/or a warning message displayed. The warning message may instruct the driver 230 to move closer towards the vehicle 115.

If, for whatever reason, a vehicle maneuvering operation such as the autonomous parking maneuver, fails, the vehicle maneuvering application may re-initiate the object recognition procedure for identifying the various vehicles present in a displayed image and execute subsequent steps as described above. Appropriate text or audible messages may be provided to the driver 230 for performing these procedures in an intuitive and easily-understood manner.

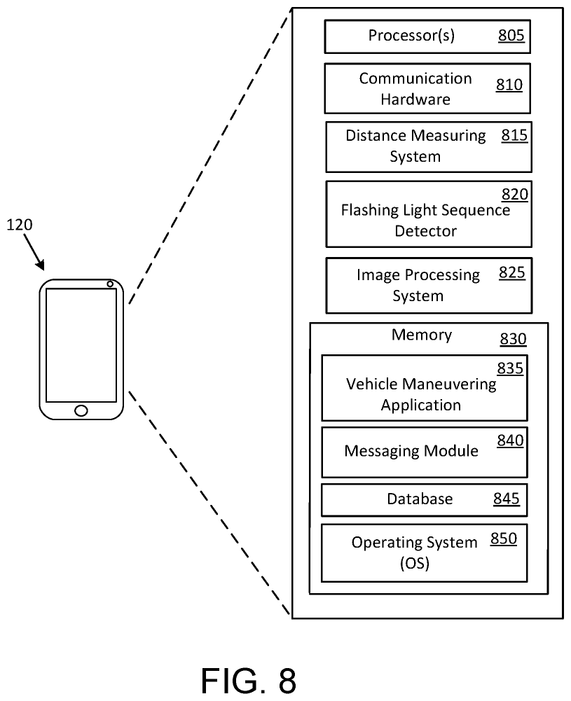

FIG. 8 shows some exemplary components that may be included in the handheld device 120 of the vehicle maneuvering system 100 in accordance with the disclosure. In this example configuration, the handheld device 120 can include a processor 805, communication hardware 810, a distance measuring system 815, a flashing light sequence detector 820, an image processing system 825, and a memory 830.

The communication hardware 810 can include one or more wireless transceivers, such as, for example, a Bluetooth® Low Energy Module (BLEM), that allows the handheld device 120 to transmit and/or receive various types of signals to/from a vehicle such as the vehicle 115. The communication hardware 810 can also include hardware for communicatively coupling the handheld device 120 to the communications network 150 for carrying out communications and data transfers with the server computer 140. In an exemplary embodiment in accordance with the disclosure, the communication hardware 810 includes various security measures to ensure that messages transmitted between the handheld device 120 and the vehicle 115 are not intercepted for malignant purposes. For example, the communication hardware 810 may be configured to provide features such as encryption and decryption of messages.

The distance measuring system 815 may include hardware such as one or more application specific integrated circuits (ASICs) containing circuitry that allows the handheld device 120 to execute distance measuring activities, such as measuring a separation distance between the handheld device 120 and the vehicle 115.

The flashing light sequence detector 820 may include hardware such as one or more ASICs containing circuitry that allows the handheld device 120 to detect one or more light flashing sequences executed by the vehicle 115 as part of a linking procedure to link the handheld device 120 to the auxiliary operations computer 110 provided in the vehicle 115 and/or to establish a visual lock between the handheld device 120 and the vehicle 115.

The image processing system 825 may include hardware such as one or more ASICs containing circuitry that allows the handheld device 120 to display images such as the ones described above with respect to FIG. 3, FIG. 4, FIG. 6, and FIG. 7. The image processing system 825 may also be used for other actions described herein, such as, for example, the object recognition procedure and for tracking of the vehicle 115.

The memory 830, which is one example of a non-transitory computer-readable medium, may be used to store an operating system (OS) 850, a database 845, and various code modules such as a vehicle maneuvering application 835 and a messaging module 840. The code modules are provided in the form of computer-executable instructions that can be executed by the processor 805 for performing various operations in accordance with the disclosure.

The vehicle maneuvering application 835 may be executed by the processor 805 for performing various operations related to autonomous vehicle maneuvering operations. For example, the vehicle maneuvering application 835 may cooperate with the communication hardware 810, the distance measuring system 815, the flashing light sequence detector 820, and/or the image processing system 825 to remotely control and assist the vehicle 115 execute an autonomous parking maneuver. The processor 805 may also execute the messaging module 840 in cooperation with the vehicle maneuvering application 835 for displaying various messages upon the handheld device 120 in accordance with the disclosure.

The database 845 can be used for various purposes such as, for example, to store a flashing light sequence, to store data pertaining to visual icons (such as the flashing icon 705), audio signals and/or haptic signals in accordance with the disclosure, and to store parameters such as a minimum visibility requirement and a maximum separation distance.

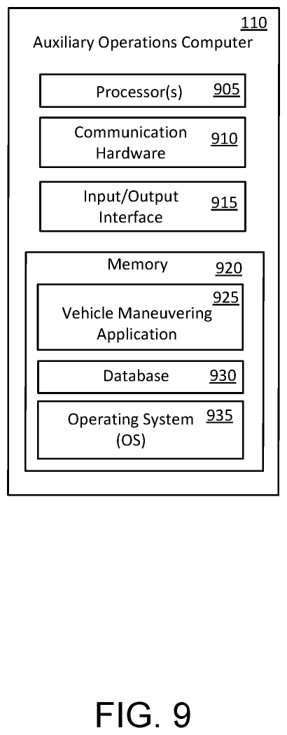

FIG. 9 shows some exemplary components that can be included in the auxiliary operations computer 110 provided in the vehicle 115. In this example configuration, the auxiliary operations computer 110 can include a processor 905, communication hardware 910, an input/output interface 915, and a memory 920.

The communication hardware 910 can include one or more wireless transceivers, such as, for example, a Bluetooth® Low Energy Module (BLEM), that allows the auxiliary operations computer 110 to transmit and/or receive various types of signals to/from the handheld device 120 via the communication nodes 130a, 130b, 130c, and 130d mounted upon the vehicle 115. The communication hardware 910 can also include hardware for communicatively coupling the auxiliary operations computer 110 to the communications network 150 for carrying out communications and data transfers with the server computer 140. In an exemplary embodiment in accordance with the disclosure, the communication hardware 910 includes various security measures to ensure that messages transmitted between the auxiliary operations computer 110 and the handheld device 120 are not intercepted for malignant purposes. For example, the communication hardware 910 may be configured to provide features such as encryption and decryption of messages.

The input/output interface 915 may include hardware that allows the auxiliary operations computer 110 to interact with the vehicle computer 105 and/or other components of the vehicle 115 for executing various actions such as, for example, controlling various lamps of the vehicle for performing a flashing light sequence.

The memory 920, which is another example of a non-transitory computer-readable medium, may be used to store an operating system (OS) 935, a database 930, and various code modules such as a vehicle maneuvering application 925. The code modules are provided in the form of computer-executable instructions that can be executed by the processor 905 for performing various operations in accordance with the disclosure.

The vehicle maneuvering application 925 may be executed by the processor 905 for performing various operations related to autonomous vehicle maneuvering operations. For example, the vehicle maneuvering application 925 may cooperate with the vehicle computer 105 to perform an autonomous parking operation and with the communication hardware 910 for exchanging signals pertaining to the autonomous parking operation with the handheld device 120. The database 930 can be used for various purposes such as, for example, to store a flashing light sequence that is recognizable by the handheld device 120.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” “an exemplary embodiment,” “exemplary implementation,” etc., indicate that the embodiment or implementation described may include a particular feature, structure, or characteristic, but every embodiment or implementation may not necessarily include the particular feature, structure, or characteristic. Moreover, such phrases are not necessarily referring to the same embodiment or implementation. Further, when a particular feature, structure, or characteristic is described in connection with an embodiment or implementation, one skilled in the art will recognize such feature, structure, or characteristic in connection with other embodiments or implementations whether or not explicitly described. For example, various features, aspects, and actions described above with respect to an autonomous parking maneuver are applicable to various other autonomous maneuvers and must be interpreted accordingly.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, cause the processor to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device such as the memory 830, can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
displaying, upon a display screen of a handheld device, an image that includes a first vehicle;
executing an action upon the handheld device to identify the first vehicle;
establishing a pairing between the handheld device and the first vehicle;
establishing a visual lock between the handheld device and the first vehicle upon establishing the pairing; and
using the visual lock to automatically track a movement of the first vehicle when the first vehicle is executing an automated maneuvering operation.

2. The method of claim 1, wherein the handheld device includes a camera and a touchscreen;
wherein executing the action to identify the first vehicle comprises one of dragging and dropping a first icon upon the first vehicle in the image displayed upon the touchscreen or touching the first vehicle in the image displayed upon the touchscreen; and further wherein establishing the pairing between the handheld device and the first vehicle comprises the first vehicle providing at least one of an audible signal or a visual signal that is recognizable by the handheld device.

3. The method of claim 2, wherein the first icon has a first color and wherein the image displayed upon the touchscreen includes a second icon having a second color, the second icon associated with a second vehicle in a group of vehicles.

4. The method of claim 1, further comprising:
providing a first warning alert when a confidence level associated with the automated maneuvering operation falls below a threshold level, the first warning alert comprising at least one of a first audible signal having a first audio pattern, a first flashing icon having a first color, a first haptic signal, or a first advisory message displayed upon the display screen for improving the visual lock; and
providing a second warning alert when the visual lock has failed, the second warning alert comprising at least one of a second audible signal having a second audio pattern a second flashing icon having a second color, a second haptic signal, or a second advisory message displayed upon the display screen for re-establishing the visual lock.

5. The method of claim 1, wherein at least one of establishing the pairing or establishing the visual lock is conditional to an individual who is holding the handheld device being located within a threshold distance of the first vehicle.

6. The method of claim 1, wherein at least one of establishing the pairing or establishing the visual lock is conditional to the handheld device being located within a threshold distance of the first vehicle.

7. The method of claim 6, further comprising:
providing a first warning alert when the handheld device is moving relative to the first vehicle or an item that is attached to the first vehicle and approaches the threshold distance; and
providing a second warning alert when the handheld device is moving relative to the first vehicle or the item that is attached to the first vehicle and exceeds the threshold distance.

8. The method of claim 1, wherein the automated maneuvering operation comprises one of an automated parking operation, an automated hitching operation, or an automated trailer maneuvering operation.

9. A method comprising:
launching a vehicle maneuvering application in a handheld device;
using the vehicle maneuvering application to execute an object recognition procedure for identifying a first vehicle in one or more images displayed on a display screen of the handheld device;
using the vehicle maneuvering application to execute a pairing operation to establishing a pairing between the handheld device and the first vehicle;
using the vehicle maneuvering application to establish a visual lock between the handheld device and the first vehicle upon establishing the pairing; and
using the visual lock to automatically track a movement of the first vehicle when the first vehicle is executing an automated maneuvering operation.

10. The method of claim 9, wherein establishing the pairing between the handheld device and the first vehicle comprises the first vehicle providing at least one of an audible signal or a visual signal that is recognizable by the handheld device.

11. The method of claim 10, wherein the audible signal has a first audio pattern that is recognizable by the handheld device and wherein the visual signal has a flashing sequence that is recognizable by the handheld device.

12. The method of claim 9, wherein the one or more images displayed on the display screen of the handheld device comprises a video stream that is updated in real time when the first vehicle is executing the automated maneuvering operation.

13. The method of claim 12, further comprising:
an operator of the first vehicle executing an action upon the handheld device to indicate that the operator is aware of the first vehicle executing the automated maneuvering operation.

14. The method of claim 13, wherein the action is at least one of holding down a button on the handheld device or retaining finger contact upon an icon that is displayed on a touchscreen display of the handheld device.

15. A handheld device comprising:
a memory that stores computer-executable instructions; and
a processor configured to access the memory and execute the computer-executable instructions to at least:
display upon a display screen of the handheld device, an image that includes a first vehicle;
detect an action executed by an operator of the handheld device to identify the first vehicle;
execute an object recognition procedure for identifying the first vehicle based on the action executed by the operator of the handheld device;
establish a visual lock between the handheld device and the first vehicle; and
track a movement of the first vehicle when the first vehicle is executing an automated maneuvering operation after establishment of the visual lock.

16. The handheld device of claim 15, wherein the action executed by the operator of the handheld device to identify the first vehicle comprises dragging and dropping a first icon upon the first vehicle in the image displayed upon the display screen.

17. The handheld device of claim 15, wherein displaying the image upon the display screen of the handheld device comprises additionally displaying a set of icons where each icon is associated with a corresponding vehicle in a group of vehicles.

18. The handheld device of claim 15, wherein establishing the visual lock is conditional to the handheld device being located within a threshold distance of the first vehicle, and wherein the processor is further configured to access the memory and execute additional computer-executable instructions to:
provide a first warning alert when the handheld device is moving relative to the first vehicle or an item that is attached to the first vehicle and approaches the threshold distance; and
provide a second warning alert when the handheld device is moving relative to the first vehicle or the item that is attached to the first vehicle and exceeds the threshold distance.

19. The handheld device of claim 15, wherein the processor is configured to access the memory and execute additional computer-executable instructions to:
recognize at least one of an audible signal or a visual signal emitted by the first vehicle; and
establish a pairing between the handheld device and the first vehicle based at least in part on recognizing the at least one of the audible signal or the visual signal.

20. The handheld device of claim 15, wherein displaying the image upon the display screen of the handheld device comprises displaying a video stream, and wherein the processor is configured to access the memory and execute additional computer-executable instructions to:
update the video stream in real time when the first vehicle is executing the automated maneuvering operation.
